(19) United States
(12) Patent Application Publication
(10) Pub. No.: US 2004/0201297 A1
(43) Pub. Date: Oct. 14, 2004

(54) Housing of stepper motor

(75) Inventor: Po-Yuan Chen, Fongyuan City (TW)

Correspondence Address: BACON & THOMAS, PLLC, 625 SLATERS LANE, FOURTH FLOOR, ALEXANDRIA, VA, 22314

(73) Assignee: NEOCENE TECHNOLOGY CO., LTD., TAICHUNG (TW)

(21) Appl. No.: 10/734,289

(22) Filed: Dec. 15, 2003

(30) Foreign Application Priority Data
Apr. 14, 2003 (TW) 92205778
Nov. 7, 2003 (CN) 200320120835.8

(51) Int. Cl. H02K 5/00; H02K 37/00

(52) U.S. Cl. 310/89; 310/49 R

(57) ABSTRACT

A stepper motor has a housing having a chamber therein. The housing frame has an annular plate and a bottom plate coupled with the annular plate and an included angle between the annular plate and the bottom plate is set at about ninety degree. A stator has a space at a center thereof and wound coils thereon to generate induced magnetic field in the space. The stator has a circumference closely attached on the inner side of the annular plate of the housing. A rotor is received in the inner space of the stator to be driven for rotation by the induced magnetic field. A motor front-plate is coupled with the housing to close the chamber, and a shaft has an end thereof coupled with the rotor for rotating along with the rotor.

### BACKGROUND OF THE INVENTION

1. Field of the Invention

The present invention relates generally to a motor, and more particularly to an improvement of a housing frame of a stepper motor.

2. Description of the Related Art

A conventional stepper motor has a housing frame-cup 90 as shown in FIG. 6. The frame-cup 90 is generally made by pressing to have a bottom part and an annular part. A chamber in the frame-cup 90 has a size slight larger than a stator to make the stator installed in the frame-cup easier. In addition, the annular part possesses a diameter at an end connected to the bottom part smaller than the diameter at the opposite top end, for de-molding of the frame-cup after been press-formed. In other words, the annular part is substantial in a cone shape and the included angle a between the bottom part and the annular part is not exactly a right 90-degree angle, it is about in a range between 92 degree to 95 degree. In addition, due to the 3D cup shape restriction, the circumference roundness of the annular part is not complete round that sometimes causes difficulties and errors of accuracy in stator installation and also causes deviations of the distance between the stator and the annular part, which in turn influence the motor electromagnetic performance.

There always are some non-uniform gaps between the stator and the annular plate in the conventional stepper motor. The gaps affect the magnetic permeability between the stator and the annular part and also make the magnetic permeability at where the top and the bottom of the housing different. The variance of the magnetic permeability resulted from the frame-cup also decreases the stability of rotation of the rotor.

### SUMMARY OF THE INVENTION

The primary objective of the present invention is to provide a housing frame of a stepper motor, which has lesser non-uniform gaps between the stator and the annular plate.

To achieve the objectives of the present invention, a stepper motor comprises a housing frame having a chamber therein. The housing frame has a separate annular plate and a bottom plate coupled with the annular plate, with an included angle between the annular plate and the bottom plate set at ninety degree. A stator has an inner space at a center thereof and wound coils thereon to generate an induced magnetic field in the space. The stator has a circumference closely attached on the inner side of the annular plate of the housing frame. A rotor is received in the inner space of the stator to be driven for rotating by the induced magnetic field. A motor-mount front-plate is coupled with the housing frame to close the chamber, and a shaft has an end thereof coupled with the rotor for rotating along with the rotor.

### BRIEF DESCRIPTION OF THE DRAWINGS

FIG. 1 is a sectional view of a first preferred embodiment of the present invention;

FIG. 2 is a top view of the frame annular plate of the first preferred embodiment of the present invention;

FIG. 3 is a sectional view of the first preferred embodiment of the present invention, showing the housing frame coupled with the motor front-plate by welding;

FIG. 4 is a sectional view of a second preferred embodiment of the present invention, showing the frame annular plate coupled with the bottom plate and covered by a injection-molded plastic layer;

FIG. 5 is a sectional view of the third preferred embodiment of the present invention; and,

FIG. 6 is sectional view of the housing frame-cup of the conventional stepper motor.

### DETAILED DESCRIPTION OF THE INVENTION

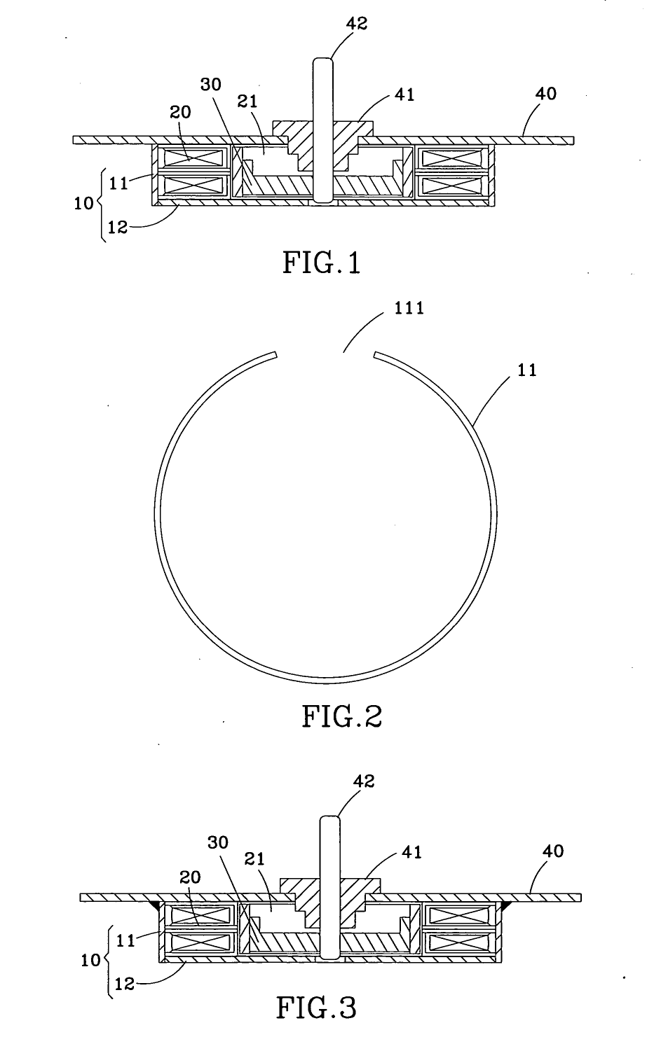

As shown in FIG. 1, a stepper motor of the first preferred embodiment of the present invention comprises:

A housing frame 10 has a chamber therein.

A stator 20 mounted in the chamber of the housing frame 10, which has a space 21 at a center thereof and a plurality of wound coils on the stator to generate induced magnetic field in the space 21.

A rotor 30 is received in the space 21 of the stator 20 to be driven for rotation by the induced magnetic field.

A motor front-plate 40 is secured on the housing frame 10 to close the chamber. The motor front-plate 40 is mounted with a bearing 41 and a shaft 42, while shaft 42 having a portion outside the housing and has a portion inside the chamber of the housing 40 and coupled with the rotor 30, such that shaft 42 rotates along with the rotor 30.

The characteristic of the present invention is that the housing frame 10 has a separate annular plate 11 and a bottom plate 12. The annular plate 11 is made of a material, which is magnetic permeable and elastic flexible. The annular plate 11 has a constant diameter from a top thereof to a bottom thereof. The bottom plate 12 has a circumference completely attached on the interior side of the annular plate 11 at where adjacent to the bottom thereof. An included angle between the annular plate 11 and the bottom plate 12 is set at ninety degree.

In another design, the annular plate 11 can also have the bottom plate closely attached on a top of the bottom plate 12 as shown in FIG. 5.

An example fabrication process of the present invention will be described hereunder for the characteristic points of the present invention. The annular plate 11 is made of a magnetic permeable metal strip, such as galvanized steel or silicon steel. As shown in FIG. 2, a flat strip plate is mold-rolled into an annular shape to form the annular plate 11, and the annular plate 11 has an open at the top and bottom end respectively and with an inner diameter thereof slightly smaller than the diameter of the stator 20.

As shown in FIG. 3, the annular plate 11 is round-fitted to the stator 20. Because the annular plate is made of an elastic flexible material, the stator 20 can be closely attached on the annular plate 11, with the same closely contact on both top and bottom side. The bottom plate 12, and then, is coupled with the annular plate 11 on the bottom thereof by precise spot welding and the motor front-plate 40 is coupled with the annular plate 11 on the top thereof also by precise spot welding.

By comparing to the conventional frame-cup structure, since the inner diameters of the annular plate 11 on both top and bottom side are the same so that the inner side of the annular plate 11 has same contact area with the stator along the top-down axial direction. The ultimate induced magnetic permeability, therefore, remains constant axially all over in the chamber of the housing 10.

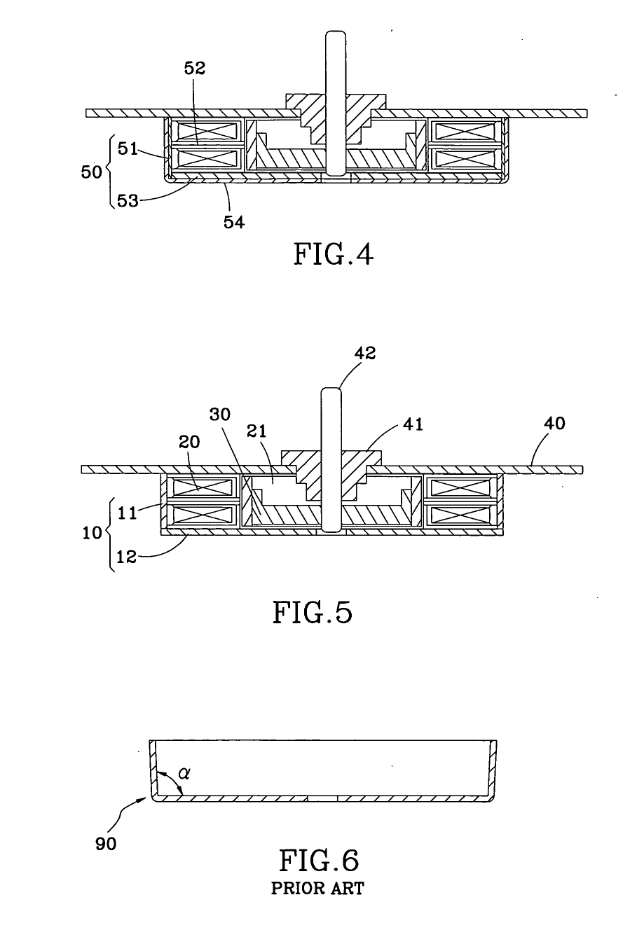

As shown in FIG. 4, the second preferred embodiment of the present invention provides a housing frame 50 having an annular plate 51 and a bottom plate 53. A stator 52 is closely attached on the inner side of the annular plate 51. A plastic layer 54, formed with the frame 50 by injection mold, covered on the annular plate 51 and the bottom plate 53 to couple them.

The present invention provides the housing having a constant diameter along the top-down axial direction, and eliminates the varied gap between the annular plate and the stator and to make uniform magnetic field distribution in the housing, so that the rotor can rotate more smoothly.

What is claimed is:

1. A stepper motor, comprising:
a housing having a chamber therein, wherein the housing fame has an annular plate and a bottom plate coupled with the annular plate, and an included angle between the annular plate and the bottom plate set at ninety degree;
a stator having a space at a center thereof and wound coils on the stator to generate induced magnetic field in the space, wherein the stator has a circumference closely attached on the inner side of the annular plate of the housing frame;
a rotor received in the inner space of the stator to be driven for rotating by the induced magnetic field;
a motor front-plate which is mounted with a shaft, while shaft having a portion outside the housing and has a portion inside the chamber of the housing and coupled with the rotor is secured on the housing frame to close the chamber.

2. The stepper motor as defined in claim 1, wherein the bottom plate is coupled with the annular plate after the stator is fixed in the annular plate.

3. The stepper motor as defined in claim 1, wherein the annular plate is made of galvanized steel and then is roll-molded into an annular shape.

4. The stepper motor as defined in claim 1, wherein the annular plate is made of silicon steel and then is roll-molded into an annular shape.

5. The stepper motor as defined in claim 1, wherein the annular plate is made of a magnetic permeable material.

6. The stepper motor as defined in claim 5, wherein the bottom plate is coupled with the annular plate by spot welding.

7. The stepper motor as defined in claim 1, further comprising a plastic layer on outer sides of the annular plate and the bottom plate.
